(19) United States
(12) Patent Application Publication
(10) Pub. No.: US 2017/0036758 A1
(43) Pub. Date: Feb. 9, 2017

(54) SYSTEMS AND METHODS FOR DAMPING ROTOR BLADE ASSEMBLIES

(71) Applicant: Sikorsky Aircraft Corporation, Stratford, CT (US)

(72) Inventors: Eric L. Nussenblatt, Stamford, CT (US); David H. Hunter, Cheshire, CT (US)

(21) Appl. No.: 15/230,683

(22) Filed: Aug. 8, 2016

Related U.S. Application Data
(60) Provisional application No. 62/202,530, filed on Aug. 7, 2015.

(51) Int. Cl. B64C 27/00; B64C 27/46

(52) U.S. Cl. CPC B64C 27/001; B64C 27/46; B64C 2027/004; B64C 2027/005

(57) ABSTRACT

A rotor blade assembly includes a blade body having a leading edge and a trailing edge. A damper element is disposed within the blade body and along a forcing axis extending between the leading and trailing edges of the blade body to apply damping force in-plane with the blade body to damp load and oppose edgewise motion of the blade body associated with the load.

### CROSS-REFERENCE TO RELATED APPLICATION

This application claims the benefit of priority under 35 U.S.C. §119(e) to U.S. Provisional Application No. 62/202,530, filed Aug. 7, 2015, which is incorporated herein by reference in its entirety.

### BACKGROUND OF THE INVENTION

1. Field of the Invention

The present disclosure relates to vibration control for rotary machinery, and more particularly to vibration control for rotorcraft blade assemblies such as in helicopters.

2. Description of Related Art

Some rotary wing aircraft include coaxial, contra-rotating rotor systems. Coaxial contra-rotating rotor systems generally include an upper rotor disk and a lower rotor disk coupled for rotation about a common axis in opposite directions. Such rotary wing aircraft can be capable of higher speeds as compared to conventional single rotor helicopters due in part to the balance of lift between advancing sides of the main rotor blades on the upper and lower rotor systems. To increase rotor speeds and reduce drag, it is advantageous to place the upper and lower rotor systems relatively close to one another along the rotor shaft axis to reduce drag on the system. Employment of rigid rotor systems, i.e., hingeless rotor systems, can allow for positioning the upper rotor disk relatively close to the lower rotor disk. However, because there typically are no lead/lag adjustment mechanisms, rigid rotor systems can exhibit edgewise or in-plane inadequately damped modes in operational regimes where low aerodynamic damping exists like operation with low collective state, such as during high speed flight and/or during ground operation. This can be a limiting factor, requiring blade design that is less optimal than otherwise possible.

Such conventional systems and methods of vibration control have generally been considered satisfactory for their intended purpose. However, there is still a need in the art for improved systems and method for vibration control that allow for rotor blade performance. The present disclosure provides a solution for this need.

### SUMMARY OF THE INVENTION

A rotor blade assembly includes a blade body having a leading edge and a trailing edge. A damper element is disposed within the blade body and along a forcing axis extending between the leading edge and the trailing edge of the blade body. The damper element is configured to apply damping force along the forcing axis to dampen loads and edgewise displacement of the rotor blade assembly associated with the load.

In certain embodiments, the blade body can extend between a blade root and a blade tip. The blade root can include a hingeless mounting fixture for rigidly supporting the blade body in a rotor blade hub for a compound rotorcraft with contra rotating rotor blade systems. The blade tip can include a swept tip profile. The damper element can be disposed along a length of the blade at a location that is closer to the blade tip than to the blade root. It is contemplated that the damper element can be disposed at a location that is at least sixty (60) percent of the distance between the blade root and the blade tip.

In accordance with certain embodiments, the damper element can oriented to dampen loads and/or displacements that are locally in-plane with the damper element. The damper element can include a spring-mass system. The mass of the spring-mass system can be movable relative to the blade body and the spring of the spring-mass system can couple the mass to the blade body. The mass of the spring-mass system can be displaceable along a portion of the forcing axis that includes the damper element and points on the leading and trailing edges of the blade body. It is further contemplated that the damper element can include a hydraulic damper, such as a piston displaceable within a hydraulic damping fluid along a portion of the forcing axis.

It is also contemplated that, in accordance with certain embodiments, the damper element can be disposed within an interior of the blade body. The damper element can be tunable such that the damper element opposes forces applied within a predetermined frequency range. The damper element can be passive, active, or can include both passive and active damper elements. A rigid rotor can include the rotor blade assembly as described above. The rigid rotor system can include a damper element with a center of gravity radially fixed relative to a main rotor axis of the rigid rotor.

A method of damping a rotor blade assembly includes receiving a load at a rotor blade assembly rigidly supported in a rotor hub, generating a damping force opposing an in-plane component of the load using a damper element disposed within the rotor blade assembly corresponding to the received load, and applying the damping force to the rotor blade assembly to reduced edgewise movement of the rotor blade assembly associated with the load.

In certain embodiments, the damping force can be applied by the damper element to the rotor blade assembly in-plane only. Applying the damping force can include applying the damping force along a forcing axis that is orthogonal relative to a longitudinal axis of the rotor blade assembly. The method can also include advancing or retarding edgewise a tip portion of the of the rotor blade assembly relative to a root portion of the rotor blade assembly. Applying the damping force can include applying the force to the rotor blade assembly at a location that is closer to a tip portion of the rotor blade assembly that to a root portion of the rotor blade assembly.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a side elevation view of an exemplary embodiment of an aircraft constructed in accordance with the present disclosure, showing a rotary wing aircraft having contra rotating rotors with rigidly supported rotor blade assemblies;

FIG. 2 is a plan view of the rotor blade assemblies of FIG. 1, showing a damper element disposed at a radially outer location of the rotor blade assembly;

FIG. 3 is a cross-sectional end elevation view of the rotor blade assembly of FIG. 1, showing a spring-mass damper element for applying damping forces edgewise relative to the blade assembly;

FIG. 4 is a cross-sectional end elevation end view of the rotor blade assembly of FIG. 1, showing a hydraulic damper element for applying damping forces edgewise relative to the blade assembly;

FIG. 5 is a chart showing damped and less damped (or undamped) responses of a rigidly supported rotor blade assembly in response to cyclic loads having a frequency corresponding to the resonant frequency of the rotor blade assembly; and

FIG. 6 schematically shows a method of damping a rotor blade using a damper element.

### DETAILED DESCRIPTION OF THE PREFERRED EMBODIMENTS

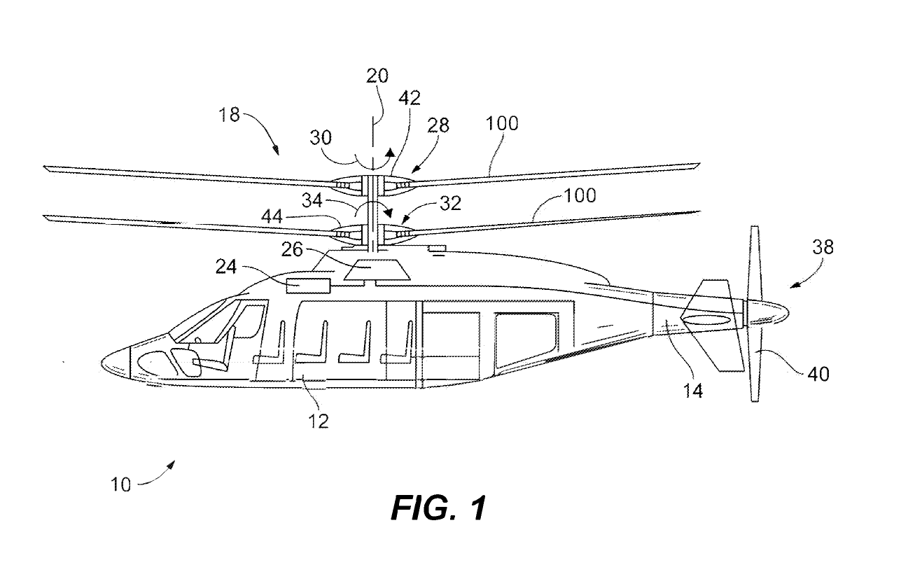

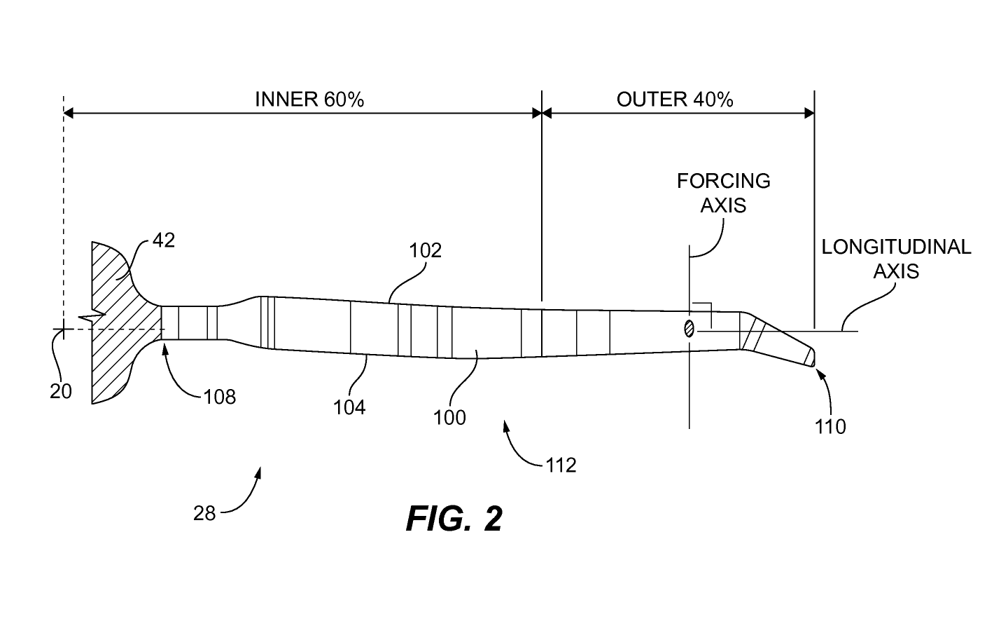

Reference will now be made to the drawings wherein like reference numerals identify similar structural features or aspects of the subject disclosure. For purposes of explanation and illustration, and not limitation, a partial view of an exemplary embodiment of a rotorcraft in accordance with the disclosure is shown in FIG. 1 and is designated generally by reference character 10. Other embodiments of rotorcraft, rotor assemblies, and methods of damping rotorcraft vibration in accordance with the disclosure, or aspects thereof, are provided in FIGS. 2-6, as will be described. The systems and methods described herein can be used aircraft such as compound rotorcraft or helicopters, however the invention is not limited to a particular type of aircraft or to aircraft in general.

Referring now to FIG. 1, an exemplary embodiment of a rotary wing aircraft 10 is shown. Rotary wing aircraft 10 includes a fuselage 12 with a longitudinally extending tail 14 and a dual, counter rotating, coaxial main rotor 18. Main rotor 18 is rotatably supported by fuselage 12 for rotation about a main rotor axis 20 and is driven by a source of mechanical rotation, for example, a gas turbine engine 24, operably connected to main rotor 18 through a gearbox 26.

Main rotor 18 includes an upper rotor 28 and a lower rotor 32 operatively connected to gearbox 26 for rotation about main rotor axis 20. Upper rotor 28 is driven in a first direction 30 about main rotor axis 20 and a lower rotor 32 driven in a second direction 34 about main rotor axis 20. First direction 30 is opposite second direction 34 such that main rotor 18 is a contra rotating main rotor. For example, if first direction 30 is clockwise about main rotor axis 20, then second direction 34 is counterclockwise about main rotor axis 20. Oppositely, if first direction 30 is counterclockwise about main rotor axis 20, then second direction 34 is clockwise about main rotor axis 20.

Both upper rotor 28 and lower rotor 32 include a plurality of rotor blade assemblies 100. In some embodiments, rotary wing aircraft 10 further includes a translational thrust system 38 supported by extending tail 14 to provide translational thrust. In the illustrated exemplary embodiment, translational thrust system 38 includes a propeller rotor 40, also operably associated with engine 24 through gearbox 26. While shown in the context of a pusher-prop configuration, it is understood that the propeller rotor 40 could alternatively be a puller prop, and may be controllably variably facing so as to provide yaw control in addition to or instead of translational thrust.

In contrast to articulated or hinged rotor systems, rotor blade assemblies 100 of upper rotor 28 and lower rotor 32 are rigidly supported with their respective rotor blade. In this respect rotor blade assemblies 100 of upper rotor 28 are connected to upper hub 42 in a hingeless arrangement and have no degrees of freedom relative to upper hub 42. Rotor blade assemblies 100 of lower rotor 32 are connected to lower hub 44 in a hingeless arrangement and have no degrees of freedom relative to lower hub 44. The rigid rotor assemblies allow for contra rotation of rotor blade assemblies 100 associated with respective rotors with relatively little separation, thereby providing improved aerodynamics relative to hinged or articulated rotors. It also means that blades of the respective upper and lower rotor systems are unable to lead or lag within the plane of rotation relative to a nominal position in response to loads exerted on the rotor blade assemblies that tend to advance or retard the rotor blade assembly relative to a nominal blade position. Such loads can result from changes in drag between advancing and retreating blades, wind gusts, and/or blade accelerations associated with change in rotor shaft tilt by way of non-limiting example. These loads can induce dynamic imbalances that the aircraft gearbox can transmit to the airframe as vibration. As will be appreciated, dampening such vibrations can avoid discomfort to aircraft passengers, wear on aircraft components, or aircraft handling challenges. While described in terms of use on a rigid blade assembly, it is to be understood and appreciated that aspects of the invention can be used to provide damping in articulated or hinged rotor systems in other embodiments.

With reference to FIG. 2, rotor blade assembly 100 is shown. Rotor blade assembly 100 has a leading edge 102 and a trailing edge 104. Leading edge 102 and trailing edge 104 extend between a root portion 108 and a tip portion 110 coupled to one another by a blade body 112, and are generally disposed in a nominal rotation plane that includes the rotor hub, e.g. upper hub 42. Root portion 108 is rigidly connected to upper hub 42, blade body 112 is connected at an inboard end to root portion 108, and tip portion 110 is connected to an outboard end of blade body 112. In illustrated exemplary embodiment tip portion 110 is disposed radially outboard of a swept segment of rotor blade assembly 100 defined by blade body 112. However, it is to be understood and appreciated that while the swept portion is shown oriented toward trailing edge 104, it is also to be understood that the swept portion need not be used in all aspects, and/or can be oriented in other directions including toward leading edge 102.

A damper element 120 is disposed within blade body 112. Damper element 120 is disposed along a forcing axis F. Forcing axis F extends between leading edge 102 and trailing edge 104 at an angle that, as illustrated in FIG. 2, is substantially orthogonal to a longitudinal axis of blade body 112. It is contemplated that forcing axis F is locally in-plane with damper element 120, locally meaning the pitch of forcing axis F in relation to the plane of the rotor blade system incorporating the rotor blade assembly may change according to twisting of blade body 112 about the longitudinal axis of the rotor blade assembly at the location of damper element 120.

Damper element 120 is disposed at a location along a length of blade body 112 that is closer to tip portion 110 than to root portion 108. In the illustrated exemplary embodiment, damper element 120 is disposed at about seventy-five (75) percent of the way between root portion 108 and tip portion 110. In embodiment contemplated herein, damper element 120 is disposed along a length of blade body 112 that is between sixty (60) percent and the full length of blade body 112. This location reduces the force that damper element 120 needs to generate in order to damp a given load, potentially allowing for use of a relatively small damping element owing to the moment arm disposed between damper element 120 and root portion 108. However, it is to be understood that damper element 120, if sized accordingly, could located in other positions along the length of blade body 112, including closer to root portion 108 in other aspects of the invention. While illustrated in FIG. 2 as a single damper element 120, it is to be understood that multiple damper elements 120 in different locations within blade body 112 could be used in other aspects of the invention.

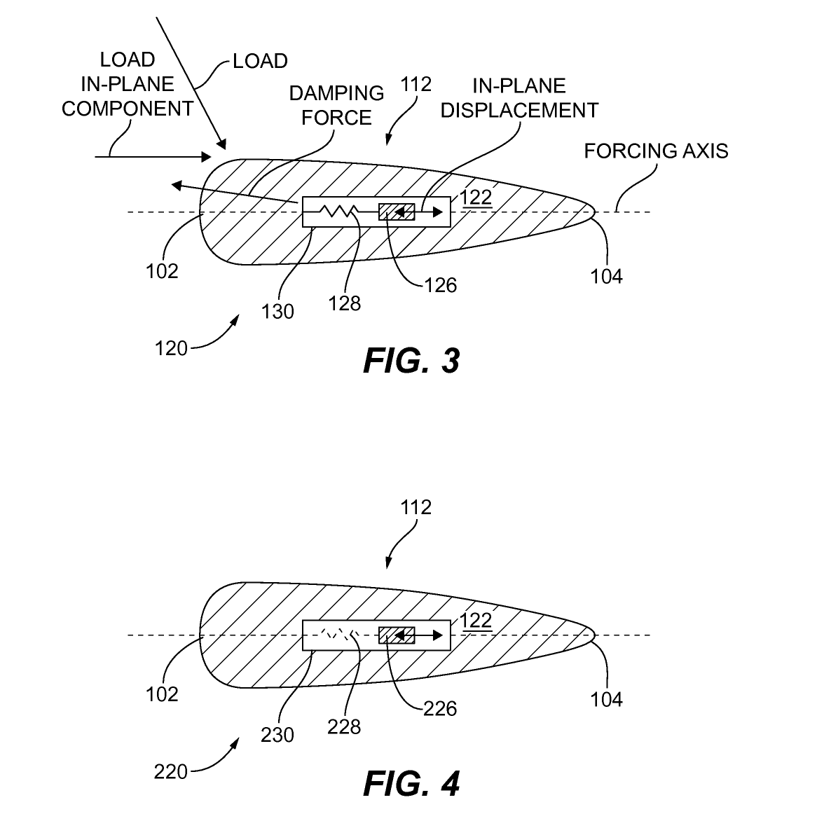

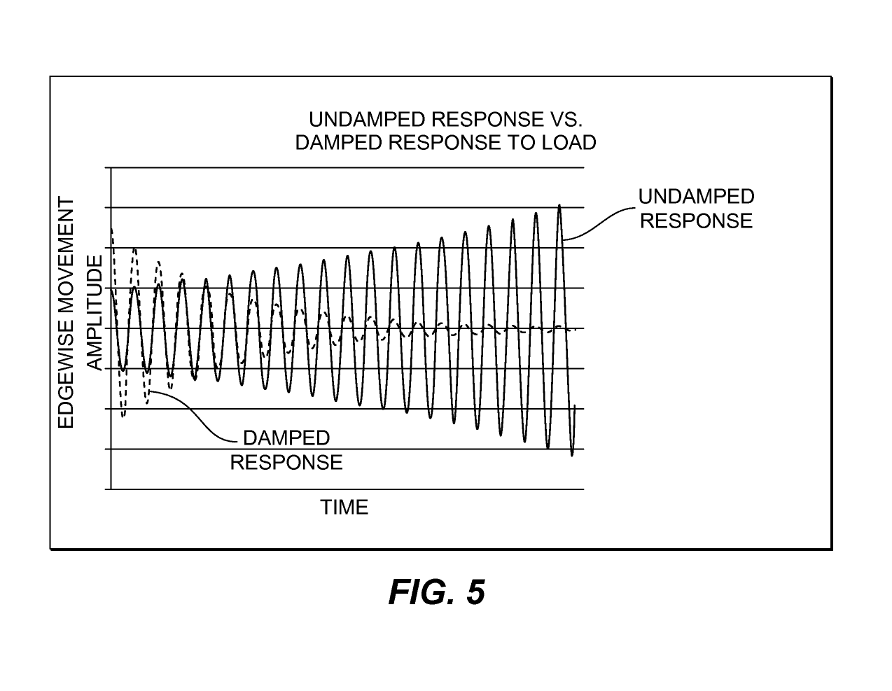

With reference to FIG. 3, blade body 112 is shown in cross-section. Damper element 120 is disposed with an interior 122 of blade body 112 and includes a spring-mass system 124 having a movable mass 126 and a spring element 128. Movable mass 126 is disposed along a damping force axis F and coupled to blade body 112 by spring element 128. Blade body 112 defines a channel 130 housing movable mass 126 and spring element 128. Response to a forcing function F with an in-plane component F_{P}, movable mass 126 displaces in the direction in-plane component F_{P}, and exerts a damping force D force in a direction opposite in-plane component F. pulling on spring element 128 in an opposite direction, thereby opposing the in-plane component of the forcing function with a damping force exerted in-plane only. As shown in FIG. 5, this dampens the vibratory response of rotor blade assembly 100 relative to differently damped rotor blade assemblies for forcing functions having a predetermined frequency. As will be appreciated, damper element 120 can be tuned to different frequencies by adjusting either or both of the weight of movable mass 126, spring constant of spring element 128, and/or the length of channel 130.

With reference to FIG. 4, a damper element 220 is shown. Damper element 220 includes a hydraulic damper and includes a hydraulic chamber 230 disposed within interior 122 of blade body 112. Hydraulic chamber 230 includes a hydraulic fluid 228 and a piston 226. As with movable mass 126, piston 226 reacts to in-plane components of forcing functions by exerting oppositely directed forces on blade body 112, thereby damping in-plane components of forcing functions with damping forces that are exerted in-plane only. Alternatively or additionally, damper element 220 may include a fluid-elastic damper.

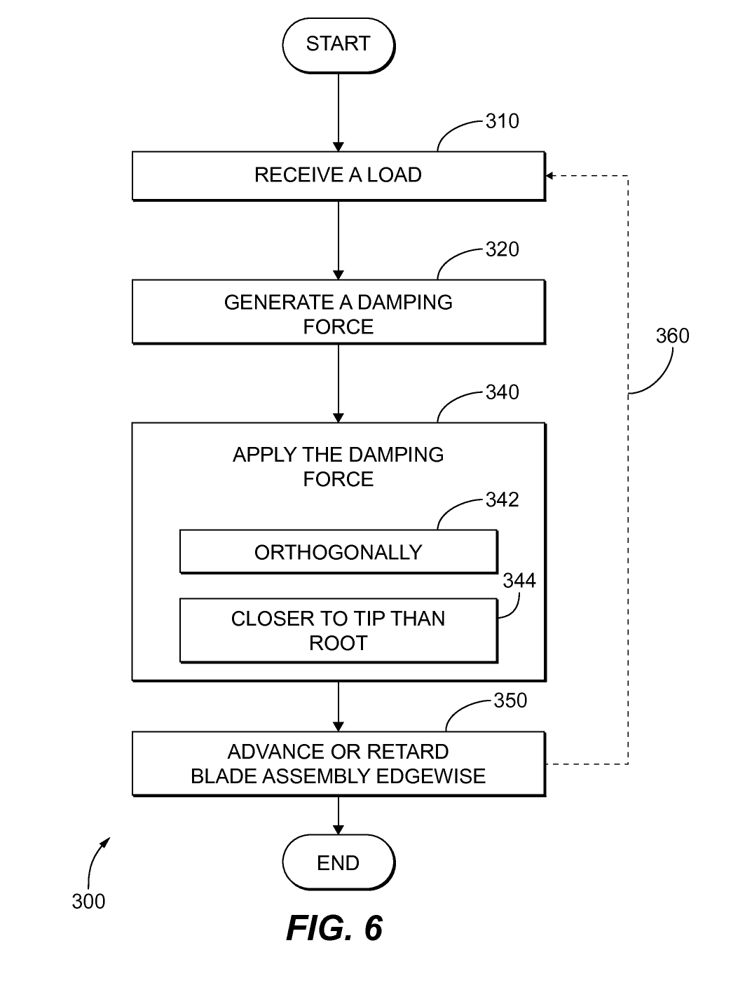

With reference to FIG. 6 a method of damping a rotor blade assembly 300 is shown. Method 300 includes receiving a load at a rotor blade assembly, e.g. rotor blade assembly 100, as shown with box 310. The load has an in-plane force component and a frequency that may correspond to a resonant frequency of the rotor blade assembly. Responsive to the received load, a damper element, e.g. damper element 120 or 220, generates a damping force in a direction that opposes an in-plane force component of the received load as shown with box 320. The generation of the damping force in operation 320 can be done using a passive system, e.g. as shown in FIG. 3, or in response to a signal in an active system, e.g. as shown in FIG. 4. The damper element 120/220 then applies the damping force on the rotor blade assembly, as shown with box 340. It is contemplated that the damping force can be applied at an angle to the longitudinal angle, such as an oblique angle or at a 90-degree angle, as shown with box 342. It is also contemplated that the force can be applied to the rotor blade assembly at a location along the length of the rotor blade assembly that is closer to a tip portion of the rotor blade assembly than to a root portion of the rotor blade assembly, as shown with box 344. In this respect the damping force tends to flex the rotor blade assembly in the edgewise direction, in-plane with a rotation plane defined at the longitudinal location of the damper element.

Method 300 may also include advancing or retarding a radially outer portion of the rotor blade assembly in the edgewise direction, as shown with box 350. The degree of edgewise movement is a function of radial position along the length of the rotor blade assembly, locations disposed relatively close to the blade root not advancing or retreating at all while locations disposed closer to the blade tip advancing or retreating by distances corresponding to their radial position. As indicated by arrow 360, the steps of method 300 may be iteratively repeated to dampen cyclically applied loads according to the frequency of load application.

Traditional articulated rotor blades can be subject to forces that advance or retard the blade position, and therefore typically include dampers interconnecting adjacent rotor blades at the blade root (i.e. at the root bearing or hinge) to dampen forces that otherwise could advance or retard the rotor blade edgewise. In contrast, rigid rotor blades have no root bearing or hinge and are less responsive to damping forces applied at the blade root for purposes advancing or retarding the rotor blade in response to a load. Rigid rotor blades can therefore exhibit edgewise inadequately damped modes in conditions where there is insufficient aerodynamic damping exists, such as in low collective states and/or during high speed flight, or load amplification when loading occurs cyclically with frequencies corresponding to the resonant frequency of the rotor blade assembly. Load amplification and edgewise inadequately damped modes can therefore impose limitations on rotor blade design that render the blade less optimal than otherwise possible.

The systems and methods of the present disclosure, as described above and shown in the drawings, provide for rotor blade assemblies with superior properties including reduced vibration in rotor systems incorporating such rotor blade assemblies. While particular embodiment have been described in relation to a rotary wing aircraft, it is understood that aspects can be used with rotors used in other machinery, including fixed wing aircraft, wind turbines, engines, maritime propulsion. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A rotor blade assembly, comprising:
a blade body having a leading edge and a trailing edge; and
a damper element disposed within the blade body along a forcing axis extending between the leading and trailing edges of the blade body, wherein the damper element is configured to apply damping force in-plane with the blade body to damp load and oppose edgewise motion of the blade body associated with the load.

2. A rotor blade assembly as recited in claim 1, wherein blade body extends between a blade root and a blade tip, wherein the damper element is closer to the tip cap than to the blade root.

3. A rotor blade assembly as recited in claim 1, wherein the blade body has an axial length extending from a blade root to a blade tip, wherein the damper element is disposed at an axial location that is more than 60% of the distance from the blade root to the blade tip.

4. A rotor blade assembly as recited in claim 1, wherein the damper element is disposed within an interior of the rotor blade assembly.

5. A rotor blade assembly as recited in claim 1, wherein the damper element includes a spring-mass system.

6. A rotor blade assembly as recited in claim 4, wherein spring-mass system includes a mass movable relative to the blade body and coupled to the blade body by the spring.

7. A rotor blade assembly as recited in claim 1, wherein the damper element includes a hydraulic damper.

8. A rotor blade assembly as recited in claim 6, wherein the hydraulic damper includes a fluid chamber fixed relative to the blade body.

9. A rotor blade assembly as recited in claim 1, wherein the damper element is a tunable damper element.

10. A rotary wing aircraft, comprising:
a fuselage;
an engine coupled to the fuselage; and
a rigid rotor system powered by the engine including a rotor blade assembly as recited in any of the preceding claims, wherein the engine rotates the rotor blade assembly about a main rotor axis to generate thrust for the aircraft.

11. A rotary wing aircraft as recited in claim 10, wherein a center of gravity of the damping element is fixed radially relative to the main rotor axis of the rigid rotor system.

12. A method of damping a rotor blade assembly, comprising:
receiving a load at a rotor blade assembly rigidly supported in a rotor hub;
generating a damping force using a damper element disposed within the rotor blade assembly corresponding to the received load; and
applying the damping force to the rotor blade assembly in-plane to reduce edgewise movement of the rotor blade assembly in response to the load.

13. A method as recited in claim 12, wherein applying the damping force includes applying the damping force along a damping axis that is orthogonal relative to a longitudinal axis of the rotor blade assembly.

14. A method as recited in claim 12, further including advancing or retarding edgewise a tip portion of the of the rotor blade assembly relative to a root portion of the rotor blade assembly.

15. A method as recited in claim 12, wherein applying the damping force includes applying the force to the rotor blade assembly at a location that is closer to a tip portion of the rotor blade assembly that to a root portion of the rotor blade assembly.
